(19) United States
(12) Patent Application Publication
(10) Pub. No.: US 2025/0194656 A1
(43) Pub. Date: Jun. 19, 2025

(54) LONGEVITY EXTENDING CONSUMABLE PRODUCTS FOR MAXIMIZING STRENGTH AND FUNCTION, METHODS OF CONSUMPTION AND MANUFACTURE

(71) Applicant: L-NUTRA INC., Plano, TX (US)

(72) Inventors: Sara CAPUTO, Bari (IT); Francesco Paolo LOCONTE, Andria (IT); Andree ARMAND, Venice, CA (US); Fabrizio SCHIRANO, Marina del Rey, CA (US); Joseph ANTOUN, Plano, TX (US)

(73) Assignee: L-NUTRA INC., Plano, TX (US)

(21) Appl. No.: 18/982,499

(22) Filed: Dec. 16, 2024

(30) Foreign Application Priority Data
Dec. 14, 2023 (IT) 102023000026688

(51) Int. Cl. A23L 33/00; A23L 2/38; A23L 2/66

(52) U.S. Cl. CPC A23L 33/40; A23L 2/38; A23L 2/66

(57) ABSTRACT

Consumable products and methods for improving health, strength, and lifespan are disclosed. The products comprise non-refined complex carbohydrates (10 to 50% of total calories), and healthy fats (20 to 40%). The consumable products can also comprise proteins (30 to 60%). L-methionine may also be included. Consumable products are provided in various forms, including bars, shakes, powders, and frozen items. The methods involve substituting one or more meals with a consumable product for predetermined periods, offering nutritional benefits without calorie restriction, improving biomarkers, and reducing frailty.

### CROSS-REFERENCE

This application claims priority to Italian Patent Application No. 102023000026688, filed Dec. 14, 2023, which application is incorporated herein in its entirety by reference.

### BACKGROUND

Technical Field: Food or foodstuffs, including the use and manufacturing thereof. More specifically, the present disclosure, relates to anti-aging food or foodstuffs that maximize strength and function, including the manufacturing and use of anti-aging food or foodstuffs that maximize strength and function, and consumption of those food or foodstuffs.

Aging is a risk factor for chronic diseases with a great impact on the social and health care system. Over the years, efforts have been made to delay and reverse the biological processes associated with aging and related diseases. Among other efforts, calorie restriction (CR) diets have been effective in ameliorating negative health outcomes and increasing the lifespan in yeast, multicellular invertebrates, and mouse models. CR has also been effective in reducing disease risk factors in humans by acting on molecular pathways involved in nutrient sensing pathways such as insulin/insulin-like growth factor pathways. Therefore, modulating these molecular pathways represents a concrete opportunity to increase longevity and duration of health also in humans. However, CR is not suitable for long-term approaches in humans since it can cause a major loss in muscle mass and has the potential for side effects in many systems.

Eating carbohydrates and proteins cause in increase in insulin and IGF-1. IGF-1 is a hormone that is similar to insulin and manages the effects of growth hormone (GH) on a body. While these hormones are necessary for macronutrient pick-up by cells, these hormones can also accelerate the rate of aging,

Over $1.1 trillion (USD) is spent annually for diet related diseases. This alarming statistic has given rise to an increase in food-based interventions to help prevent, manage and treat diet related diseases. In 2022 the United Nations estimated that there were 593,000 centenarians around the world. The number of centenarians is projected to increase to 3.7 million by 2050. With age, however, comes an increased risk for disease. That risk of disease is exacerbated by diet. It goes without saying, people don't want to live long unless they can live healthy and strong and nutrition is a key component to successful aging.

What is needed are food and foodstuffs that are formulated to achieve or surpass the effects of CR on longevity, do not require a reduction in calorie intake, do not cause a loss in muscle and bone mass, and/or maintain function and strength higher than what can be achieved with other diets that do not increase longevity.

### SUMMARY

Disclosed are consumable products and methods for improving overall health, lifespan, strength, and function. The disclosed foods and foodstuffs are formulated to: achieve or surpass the effects of CR on longevity, do not require a reduction in calorie intake, do not cause a loss in muscle and bone mass, and/or maintain function and strength higher than what can be achieved with other diets that do not increase longevity. Also disclosed are methods of manufacturing food and foodstuffs.

In at least one aspect, methods for manufacturing the consumable products are disclosed, which involve providing the aforementioned components, optionally including additional ingredients such as liquid carriers and supplements, and combining them into consumable forms using mixing and blending techniques. The healthy fats may include fish meals, fish oil, and olive oil, and the proteins may be derived from sources including legumes and/or fish meals.

In another aspect, methods for improving overall health and lifespan by substituting meals with the consumable products are disclosed. These methods provide effective nutrition without requiring calorie restriction, promoting metabolic health and reducing frailty. Additionally, supplement components, including vitamins, minerals, and amino acids, may be incorporated to enhance the nutritional benefits.

Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
U.S. Pat. No. 11,504,408 B2 issued Nov. 22, 2022 to Longo et al.;
U.S. Pat. No. 11,284,640 B2 issued Mar. 29, 2022 to Brandhorst et al.;
U.S. Pat. No. 10,015,980 B2 issued Jul. 10, 2018 to Longo et al.;
US Publication US 2013/261183 A1 published Oct. 3, 2013, to Bhagat; KR 102391091 B1 issued Apr. 27, 2022 to Lee et al.;
Brandhorst, et al. A Periodic Diet that Mimics Fasting Promotes Multi-System Regeneration, Enhanced Cognitive Performance, and Healthspan. Cell Metabolism 22, 86-99 (2015). https://doi.org:10.1016/j.cmet.2015.05.012;
Duregon, et al., R. Intermittent fasting: from calories to time restriction. Geroscience 43, 1083-1092 (2021). https://doi.org:10.1007/s11357-021-00335-z;
Fontana, et al., Extending Healthy Life Span-From Yeast to Humans. Science 328, 321-326 (2010). https://doi.org:10.1126/science.1172539;
Mattison, et al. Caloric restriction improves health and survival of rhesus monkeys. Nature Communications 8 (2017). https://doi.org:10.1038/ncomms14063;
Mikton, et al., Ageism: a social determinant of health that has come of age. Lancet 397, 1333-1334 (2021). https://doi.org:10.1016/s0140-6736(21)00524-9;
Miller, et al. Methionine-deficient diet extends mouse lifespan, slows immune and lens aging, alters glucose, T4, IGF-I and insulin levels, and increases hepatocyte MIF levels and stress resistance. Aging Cell 4, 119-125(2005). https://doi.org:10.1111/j.1474-9726.2005.00152.x;
Niccoli, et al., Ageing as a Risk Factor for Disease. Current Biology 22, R741-R752 (2012). https://doi.org:10.1016/j.cub.2012.07.024;
Trautman, et al., Protein restriction and branched-chain amino acid restriction promote geroprotective shifts in metabolism. Aging Cell 21 (2022). https://doi.org:10.1111/acel.13626; and
Wei, et al. Fasting-mimicking diet and markers/risk factors for aging, diabetes, cancer, and cardiovascular disease. Science Translational Medicine 9 (2017). https://doi.org:10.1126/scitranslmed.aai8700.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a line graph showing probability of female and male survival over time for mice comparing a western diet (WD) and a longevity diet (LD) followed by a longevity high strength and function (LHSF) diet;

FIGS. 2A-2D are line graphs illustrating female and male body weight for mice over time comparing a WD, a healthy high protein diet (HHPD), and an LD followed by an LHSF;

FIGS. 3A-3H are bar graphs illustrating male and female mice body weight (BW) fat mass, lean mass, and relative lean mass for different diets;

FIGS. 4A-4F are bar graphs illustrating male and female frailty, grip strength and rotarod over time;

FIGS. 5A-5C are graphs showing the impact of switching mice from a standard chow to different diets;

FIGS. 6A-6B are bar graphs showing frailty over time;

FIGS. 7A-7B are bar graphs showing cognition performance and motor coordination over time;

FIG. 8 is a table with a formulation for a longevity diet;

FIG. 9 is a table with a formulation for a longevity diet without protein sources;

FIG. 10 is a table of protein and amino acid supplementation;

FIGS. 11A-11B are nutritional information for a longevity extending consumable product to extend longevity while maximizing strength and function;

FIGS. 12A-12B are nutritional information for a longevity extending consumable product to extend longevity while maximizing strength and function;

FIGS. 13A-13B are nutritional information for a longevity extending consumable product to extend longevity while maximizing strength and function; and

FIGS. 14A-14E are ingredients for an exemplary longevity extending consumable product to extend longevity while maximizing strength and function.

### DETAILED DESCRIPTION

Reference will now be made in detail to presently preferred compositions, embodiments, and which constitute modes of practicing the teachings in this disclosure. As will be appreciated by those skilled in the art, specific details disclosed herein should not be interpreted as limiting, but merely as representative for any aspect of the disclosure and/or as a representative basis for teaching one skilled in the art to variously employ the present disclosure.

A longevity diet (LD) composition for improving overall health and lifespan is provided. The disclosed LD compositions can be integrated into other diets by adjusting the overall proteins, carbohydrates and fats consumed to account for the protein, carbohydrate and fat composition of a product produces according to the formations disclosed herein to achieve an overall target consumption of proteins, carbohydrates and fats consumed. The longevity diet, without any calorie or time restriction, has been shown here to be effective in improving lifespan, controlling blood glucose, and remodeling body composition with effects on biomarkers for metabolic dysfunction and aging-related diseases. These effects are attributable to a specific composition providing high nourishment but designed to achieve rapid and strong metabolic effects including fat loss and improved insulin sensitivity, etc. with minimal muscle loss in a short period.

The LD composition has a total calorie profile and includes non-refined complex carbohydrates in an amount ranging from about 10 to 50 percent, inclusive, of the total calories of the LD composition. The carbohydrate component of the compositions may be 15 to 40 percent, inclusive, of the total calories of the LD composition. Fats, and in particular, healthy fats in an amount ranging from about 15 to 45 percent, inclusive, of the total calories of the LD composition. The fat component of the compositions may be healthy fats in an amount of about 20 to 40 or even 25 to 35 percent, inclusive, of the total calories of the LD composition. The LD compositions can also include proteins in an amount ranging from about 30 to 60 percent, inclusive, of the total calories of the compositions. Alternatively, the proteins may be in the amount of 32 to 55 percent, inclusive, of the total calories of the LD composition. For example, by calories, a solid bar product according to the LD composition may be 20 to 40 percent fats, 30 to 40 percent carbohydrates, and 30 to 50 percent proteins. By way of another example, a shake product according to the LD composition may be 20 to 40 percent fats, 10 to 30 percent carbohydrates, and 40 to 60 percent proteins by calories.

The non-refined complex carbohydrates include types of carbohydrates that are minimally refined. These types of carbohydrates retain most of their natural fiber and nutritional as compared to completely unrefined carbohydrates. Examples of non-refined complex carbohydrates include, but are not limited to, whole grains, vegetables, legumes, fruits, and nuts. In some refinements, non-refined complex carbohydrates are present in an amount of at least 4 percent, 6, percent, 8 percent, 10 percent, 12 percent, 15 percent, 17 percent, or 19 percent of the total calories of the LD composition and at most 70 percent, 65 percent, 60 percent, 55 percent, 50 percent, 46 percent, 44 percent, 42 percent, 40 percent, or 38 percent of the total calories of the LD composition. Compositions in a bar form tend to favor higher carbohydrate levels, such as having at least 4 percent, 6, percent, 8 percent, 10 percent, 12 percent, 15 percent, 17 percent, or 19 percent, 20 percent, 22 percent, 25 percent, 28 percent, 30 percent, 32 percent, 33 percent, or 35 percent calories in the bar due to carbohydrates. Shake or powder forms of the compositions tend to favor lower carbohydrates, such as having at most 70 percent, 65 percent, 60 percent, 55 percent, 50 percent, 46 percent, 44 percent, 42 percent, 40 percent, 38 percent, 35 percent, 32 percent, 30 percent, 28 percent, 26 percent, 24 percent, 22 percent, or 20 percent calories in the shake or powder from carbohydrates.

Additional carbohydrate components can also be included with the non-refined complex carbohydrates that are selected from potato starch, chickpea flour, black bean flour, borlotti beans, cabbage, green beans, leeks, tomatoes, parsley, konjac flour, acacia, dates, chicory root fiber, carrot, celery, onion, peas, potatoes, pumpkins, chard, spinach, zucchini, and basil.

In some refinements of the diet, the healthy fats are present in an amount of at least 15 percent, 20 percent, 22 percent, 24 percent, or 26 percent of the total calories of the LD composition and at most 45 percent, 40 percent, 38 percent, 36 percent, 34 percent, or 32 percent of the total calories of the LD composition. In a further refinement of the diet, the healthy fats include unsaturated fats including monounsaturated fats and polyunsaturated fats but not saturated fats. Examples of healthy fats include, but are not limited to, olive oil, avocado oil, nut oil, fatty fish oil, flaxseed oil, walnut oil, sunflower oil, sesame oil, safflower oil, soybean oil, grapeseed oil, pumpkin seed oil, pistachio oil, canola oil, peanut oil, hazelnut oil, macadamia nut oil, almond oil, algal oil, chia seed oil, hemp seed oil, omega-3 fatty acids, omega-6 fatty acids, and combinations thereof. High purity olive oil, such as extra virgin olive oil, may be used as the fat source with or without additional healthy fats.

In some refinements, the proteins are present in an amount of at least 20 percent, 25 percent, 27 percent, 29 percent, 30 percent, or 32 percent of the total calories of the LD composition and at most 75 percent, 70 percent, 65 percent, 60 percent, 58 percent, 56 percent, 54 percent, 53 percent, 52 percent, 50 percent, 48 percent, 45 percent, 43 percent, 41 percent, 39 percent, or 37 percent of the total calories from proteins in the LD composition. In another aspect of the diet, the proteins are at least partially provided by legumes and/or fish meals. Plant proteins, such as chickpea protein isolate, black bean protein, and pea protein isolate can be used. Compositions in a shake or powder form tend to favor higher protein levels, such as having at least 4 percent, 6, percent, 8 percent, 10 percent, 12 percent, 15 percent, 17 percent, or 19 percent, 20 percent, 22 percent, 25 percent, 28 percent, 30 percent, 32 percent, 33 percent, 35 percent, 40 percent 45 percent 47 percent, 49 percent, 50 percent, 51 percent, 52, percent, or 53 percent of calories in the bar due to protein. Bar forms tend to favor lower protein levels, such as having at most 75 percent, 70 percent, 65 percent, 60 percent, 58 percent, 56 percent, 54 percent, 53 percent, 52 percent, 50 percent, 48 percent, 45 percent, 43 percent, 41 percent, 39 percent, or 37 percent of the total calories from proteins in the LD composition.

In another aspect of the diet, the LD composition includes a carbohydrate component selected from group consisting or comprising of potato starch, chickpeas flour, black beans flour, borlotti beans, cabbage, green beans, leeks, tomatoes, parsley, carrot, celery, onion, peas, potatoes, pumpkins, konjac flour, acacia, dates, chicory root fiber, chard, spinach, zucchini, basil, and combinations thereof, the carbohydrate component formulated to provide non-refined complex carbohydrates in an amount ranging from about 10 to 50 percent or 15 to 40 percent inclusive, of the total calories of the LD composition as set forth above.

In another aspect of the diet, the LD composition includes a fat component that is a healthy fat including unsaturated fats including monounsaturated fats and polyunsaturated fats but not saturated fats. Examples of healthy fats include, but are not limited to, olive oil, avocado oil, nut oil, fatty fish oil, flaxseed oil, walnut oil, sunflower oil, sesame oil, safflower oil, soybean oil, grapeseed oil, pumpkin seed oil, pistachio oil, canola oil, peanut oil, hazelnut oil, macadamia nut oil, almond oil, algal oil, chia seed oil, hemp seed oil, fish oil, fish meal, omega-3 fatty acids, omega-6 fatty acids, and combinations thereof. High purity olive oil, such as extra virgin olive oil, may be used as the fat source with or without additional healthy fats. selected from a group consisting or comprising of fish meal, olive oil, fish oil, and combinations thereof. Characteristically, the fat component is formulated to provide fats in an amount ranging from about 15 to 45 percent, inclusive, of the total calories as set forth above.

In yet another aspect of the diet, the LD composition includes a supplement component (i.e., the LD supplement) selected from a group consisting or comprising of mineral mix, vitamin mix, calcium phosphate/carbonate, choline bitartrate, TBHQ antioxidant, dicalcium phosphate, and combinations thereof. In a refinement, a supplement component is provided as a powder or liquid including isolates and/or concentrates selected from a group consisting or comprising of proteins from black beans, chickpeas, borlotti beans, green beans, peas, fish meal, 1-methionine, and combinations thereof.

The LD composition can further include a liquid carrier. In a refinement, the liquid carrier includes water. In a further refinement, the liquid carrier is the only liquid carrier. In a further refinement, the LD composition is formulated as a powder-based shake. In still a further refinement, the LD composition is formulated as a powder-based shake with the components as set forth above and the balance being water.

Methods are also provided that include a step of substituting at least one subject's meal per day with the composition set forth above for a first predetermined number of days. In a variation, the first predetermined number of days is from 1 to 60 days. In some refinements, the first predetermined number of days at least 1 day, 2 days, 5 days, 10 days, 20 days, or 30 days. In further refinements, the first predetermined number of days at most 100 days, 50 days, 30 days, 20 days, 10 days, or 5 days.

Additionally, a longevity diet high strength and function (LHSF) composition for improving overall health, strength, function, and lifespan is provided. The LHSF composition includes non-refined complex carbohydrates in an amount ranging from about 10 to 45 percent, inclusive, of the total calories of the LHSF composition; proteins in an amount ranging from about 25 to 60 percent, inclusive, of the total calories of the LHSF composition; healthy fats in an amount ranging from about 20 to 40 percent, inclusive of the total calories of the LHSF composition; and L-methionine. Typically, the L-methionine is present in an amount ranging from about 0.1 weight percent to about 5 weight percent, inclusive, of the total weight of the LHSF composition. Additionally, the total weight percent of L-methionine may be at least 0.25, 0.5, 0.75, or 1 weight percent L-methionine and at most 4 weight percent, 3 weight percent, or 2.5 weight percent L-methionine.

In a variation of the LHSF composition, fats are optimized, in terms of intake, to provide a balanced calorie ratio of omega-6 to omega-3 of at least 1.5:1, 2:1, 2.1:1, 2.2:1, 2.3:1, 2.4:1, 2.5:1, 2.6:1, 2.7:1, 2.8:1, and 2.9:1. In further refinements, fats are optimized, in terms of intake, to provide a balanced calorie ratio of omega-6 to omega-3 of at most 5:1, 4.5:1, 4:1, 3.9:1, 3.8:1, 3.7:1, 3.6:1, 3.5:1, 3.4:1, 3.3:1, 3.2:1, and 3.1:1.

In another aspect, the healthy fats are at least partially provided by fish meals, fish oil, and olive oil. The proteins can at least partially be provided by legumes and/or fish meals. Additionally, the LHSF composition includes a carbohydrate component selected from a group consisting or comprising of potato starch, chickpeas flour, black beans flour, borlotti beans, cabbage, green beans, leeks, tomatoes, parsley, carrot, celery, onion, peas, potatoes, pumpkins, chard, spinach, zucchini, basil, and combinations thereof, the carbohydrate component formulated to provide non-refined complex carbohydrates in an amount ranging from about 35 to 70 percent, inclusive, of the total calories of the longevity diet composition.

The LHSF composition can also be formulated to include a fat component selected from a group consisting or comprising of fish meal, olive oil, fish oil, and combinations thereof. Characteristically, the fat component is formulated to provide fats in an amount ranging from about 15 to 45 percent, inclusive, of the total calories. The LHSF composition can also include an LHSF supplement component selected from a group consisting or comprising of a mineral mix, a vitamin mix, calcium phosphate/carbonate, choline bitartrate, TBHQ antioxidant, dicalcium phosphate, and combinations thereof. In a refinement, a LHSF supplement component is provided as a powder or liquid including isolates selected from a group consisting or comprising of proteins from black beans, chickpeas, borlotti beans, green beans, peas, fish meal, 1-methionine, and combinations thereof. In a further refinement, the LHSF supplement component includes pure L-methionine supplementation or L-methionine provided by fish meal, or L-Methionine provided by a plant-based protein source rich in methionine. In a further refinement, the supplement component includes pure L-methionine supplementation or L-methionine provided by fish meal, or L-methionine provided by a synthetic or plant-based protein source rich in methionine.

In another aspect, the LHSF composition includes a liquid carrier. In a refinement, the liquid carrier includes water. In a further refinement, the liquid carrier is the only liquid carrier. In a further refinement, the LHSF composition is formulated as a shake, and in particular, a powder-based shake. In still a further refinement, the LHSF composition is formulated as a powder-based shake with the components as set forth above and the balance being water.

In still another aspect, a method includes a step of substituting at least one subject's meal per day with the LHSF composition set forth above for a second predetermined number of days. In a variation, the second predetermined number of days is from 1 to 60 days. In some refinements, the second predetermined number of days at least 1 day, 2 days, 5 days, 10 days, 20 days, or 30 days. In further refinements, the second predetermined number of days at most 100 days, 50 days, 30 days, 20 days, 10 days, or 5 days.

In yet another aspect, a method comprising substituting at least one subject's meal per day with the LD composition set forth above for a first predetermined number of days followed by substituting at least one subject's meal per day with the LHSF composition set forth above for a second predetermined number of days. In a variation, the first predetermined number of days is from 1 to 60 days. In some refinements, the first predetermined number of days at least 1 day, 2 days, 5 days, 10 days, 20 days, or 30 days. In further refinements, the first predetermined number of days at most 100 days, 50 days, 30 days, 20 days, 10 days, or 5 days. In a variation, the second predetermined number of days is from 1 to 60 days. In some refinements, the second predetermined number of days at least 1 day, 2 days, 5 days, 10 days, 20 days, or 30 days. In further refinements, the second predetermined number of days at most 100 days, 50 days, 30 days, 20 days, 10 days, or 5 days.

An LD composition without protein sources is also provided. The protein-free LD composition includes, for example, non-refined complex carbohydrates in an amount ranging from about 35 to 70 percent, inclusive, of the total calories of the LD composition and healthy fats in an amount ranging from about 15 to 45 percent, inclusive, of the total calories.

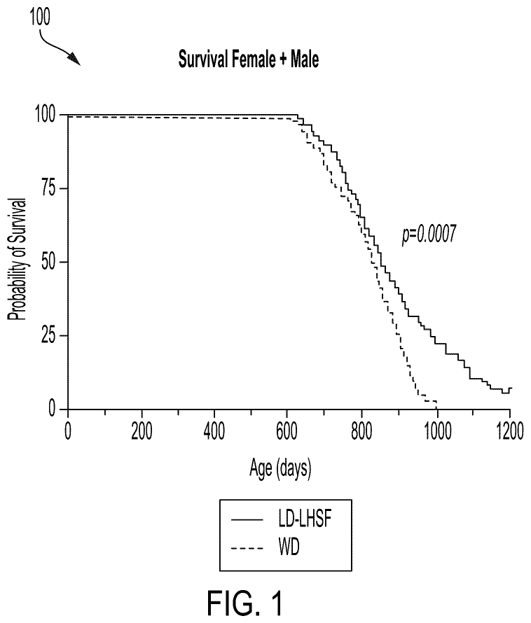

Turning now to the data that supports the diets, the line graph 100 in FIG. 1 illustrates the probability of female and male survival over time (days) comparing a western diet (WD) and a LD followed by a longevity diet high strength and function (LHSF) diet shows an increase in survival. The LD followed by LHSF diet increases the lifespan of female and male HET3 mice. Kaplan-Meier plots of survival curves comparing mice treated with LD and WD. Each group consisted of 84 (LD—LHSF) and 82 (WD) mice. Treatments continued until mice died or became moribund.

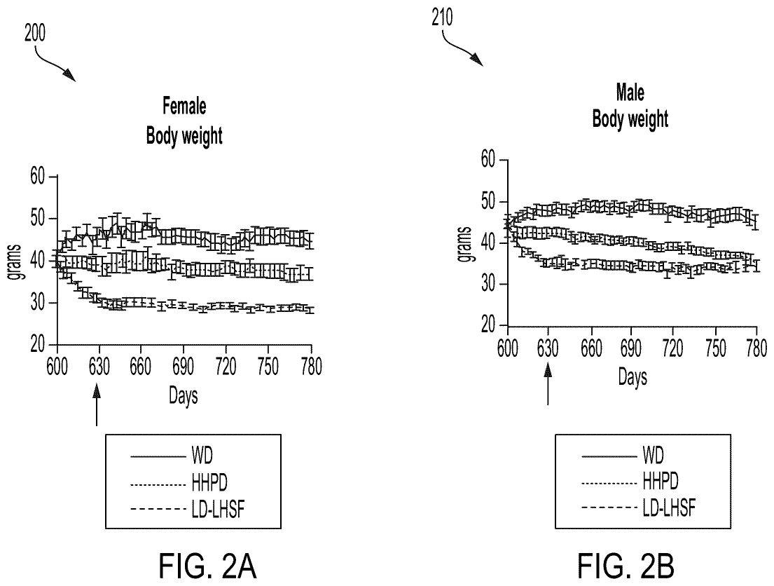

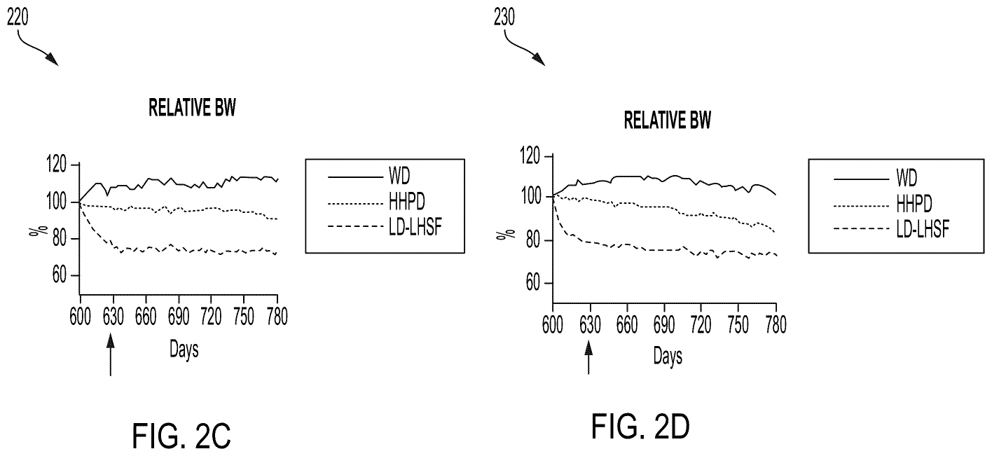

The line graphs 200, 210, 220, 230 in FIGS. 2A-2D illustrates female 200 and male 210 body weight for mice over time comparing a WD, a healthy high protein diet (HHPD), and an LD followed by an LHSF. LD induces rapid weight loss in both females and males HET3 mice over time. Switching to the LHSF1 diet after 2-4 weeks stabilizes and maintains the body weight. FIGS. 2A and 2C illustrate female absolute body weight 200 and female relative body weight 230; FIGS. 2B and 2D illustrate male absolute body weight 210 and male relative body weight 230. The line graphs show results following 6 months of intervention starting at 20 months of age. The upward arrows below days indicate when the switch between LD and LHSF takes place.

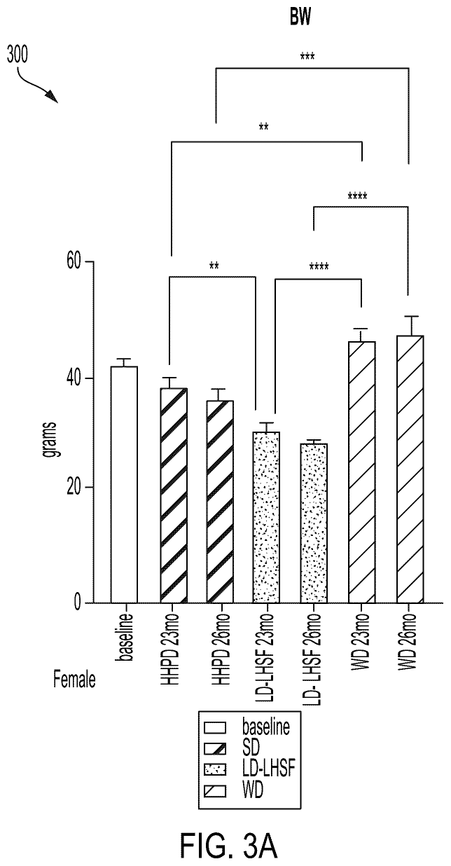

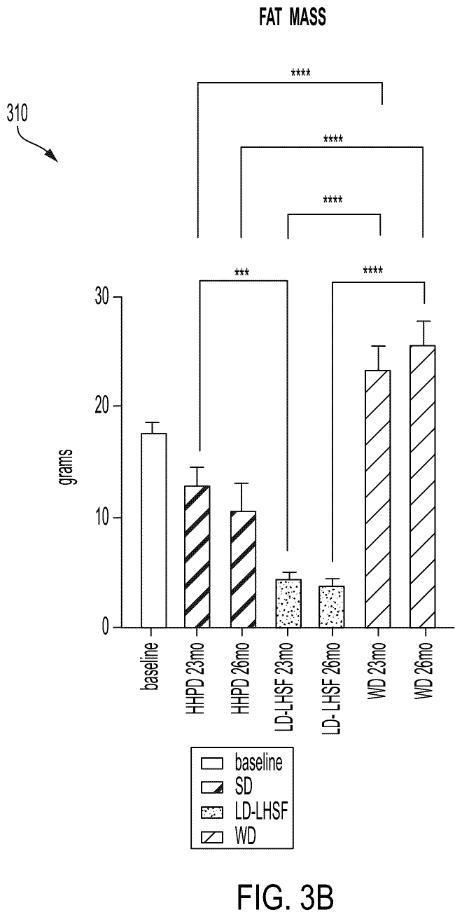

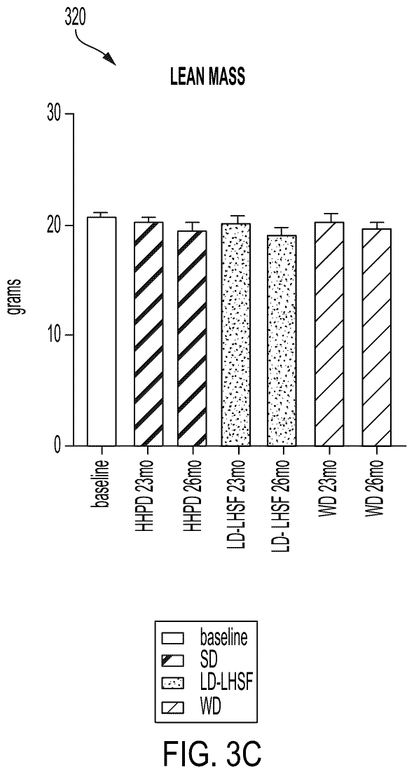

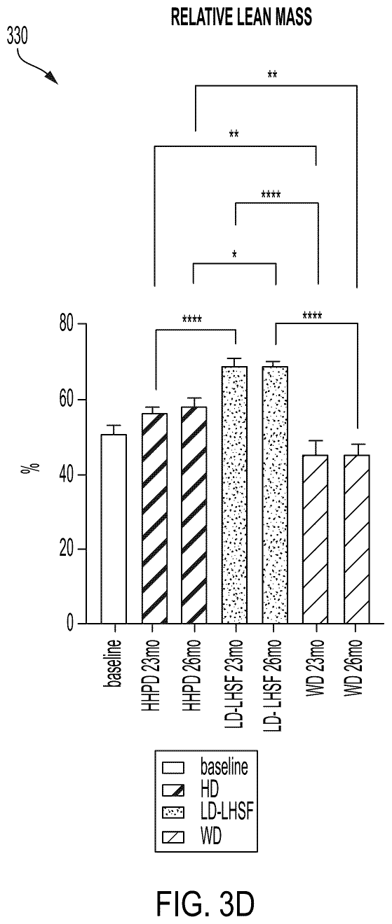

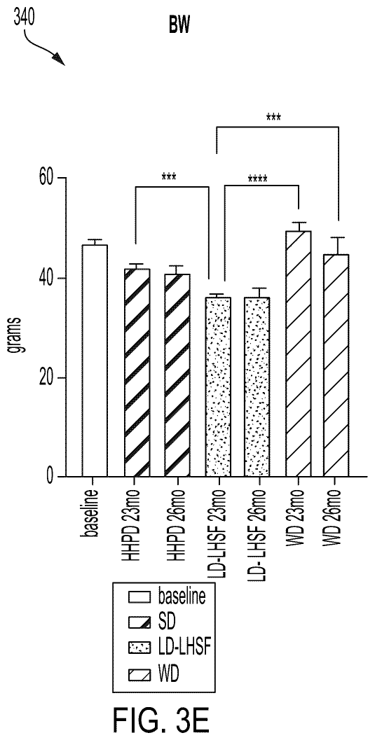

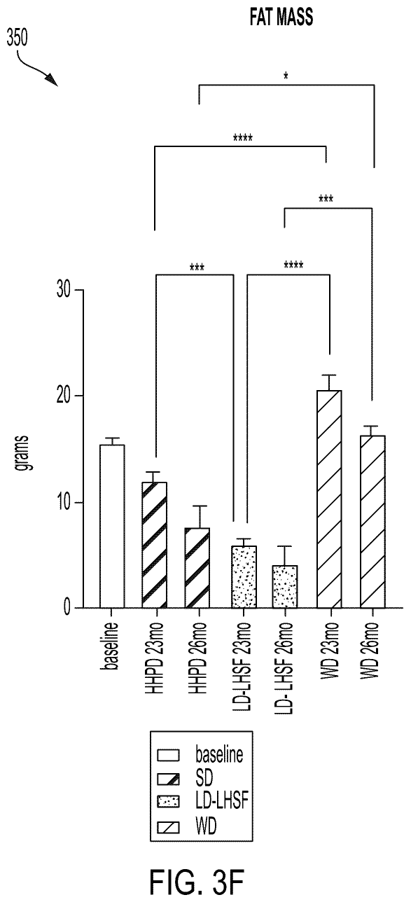

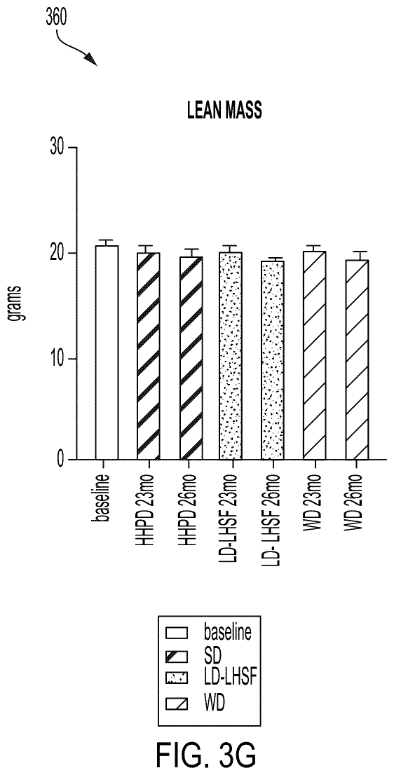

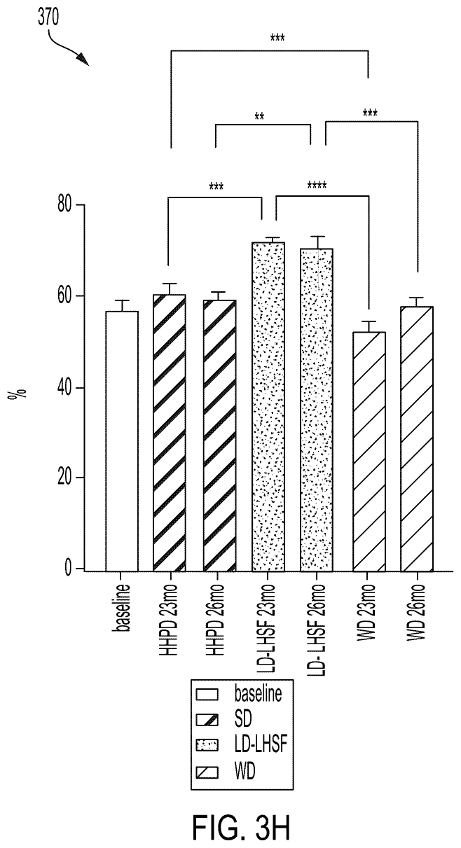

FIGS. 3A-3H are bar graphs 300, 310, 320, 330, 340, 350, 360, 370 illustrating male and female mice body weight (BW) fat mass, lean mass, and relative lean mass for different diets over time. When the LD is followed by LHSF the impact of the diets exerts a strong effect on the body composition of both female and male HET3 mice. As appreciated from the data, the LD—LHSF intervention significantly reduces female body weight (FIG. 3A) and male body weight (FIG. 3E) and female fat mass (FIG. 3B) and male fat mass (FIG. 3F) while maintaining female lean body mass expressed as absolute (FIG. 3C) male lean body mass expressed as absolute (FIG. 3G) and female relative lean mass (FIG. 3D) and male relative lean mass (FIG. 3H) after 3 and 6 months of continuous feeding ad libitum. Fat mass and lean mass were analyzed by nuclear magnetic resonance (NMR) using the Minispec LF90 (Bruker). Baseline, 20 months old HET3 mice (white); HHPD, Healthy High Protein Diet (black); LD—LHSF, Longevity Diet switched to Longevity Diet High Strength and Function; WD, Western Diet.

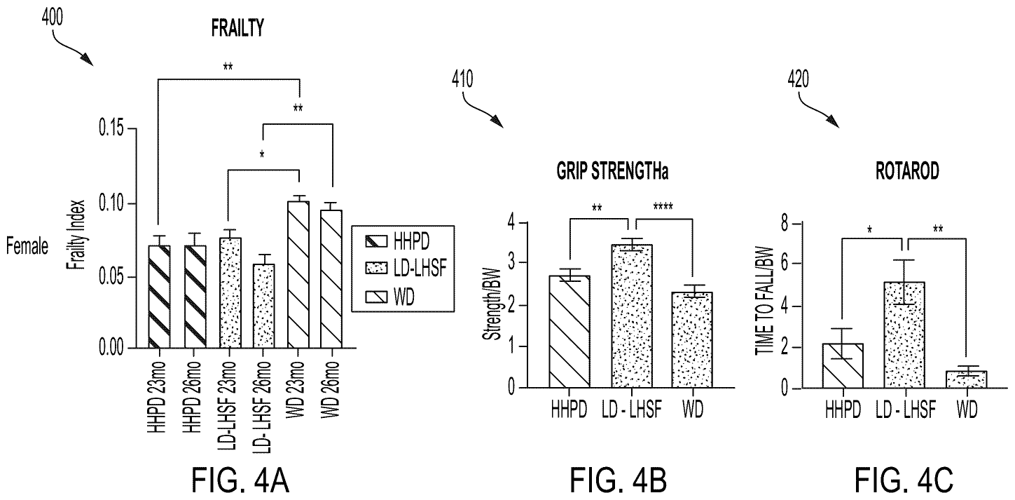

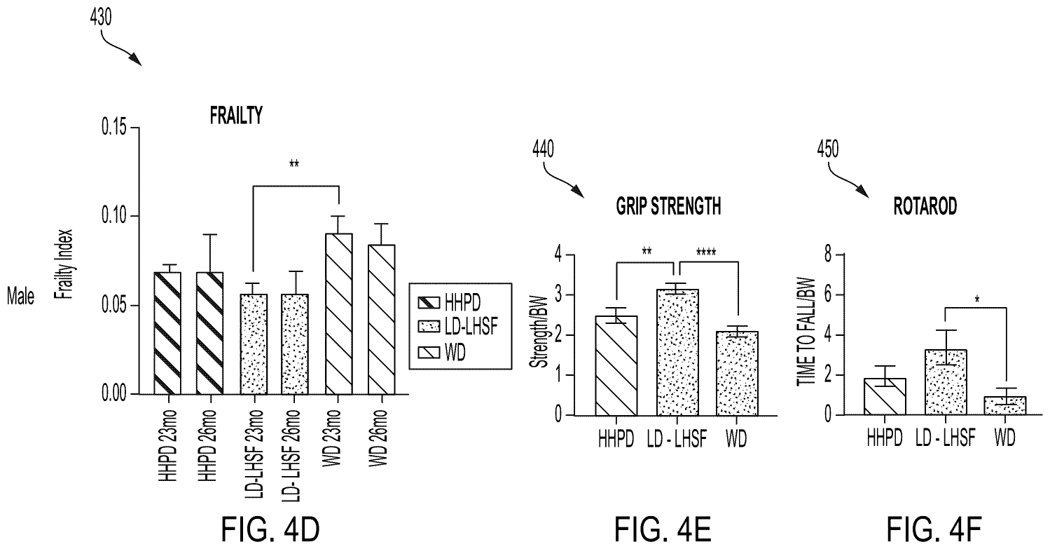

FIGS. 4A-4F are bar graphs 400, 410, 420, 430, 440, 450 illustrating male and female frailty (FIGS. 4A and 4D), grip strength (FIGS. 4B and 4E) and rotarod (FIGS. 4C and 4F) over time. The body composition remodeling improves frailty, muscle strength, and motor coordination of both female and male HET3 mice. Frailty Index performed after 3 and 6 months of continuous feeding ad libitum. B, E) Grip Strength performed after 4 months of continuous feeding ad libitum. C, F) Rotarod performed after 4 months of continuous feeding ad libitum. HHPD, Healthy High Protein Diet (black); LD—LHFS, Longevity Dietl switched to Longevity Diet High Strength and Function1; WE, Western Diet.

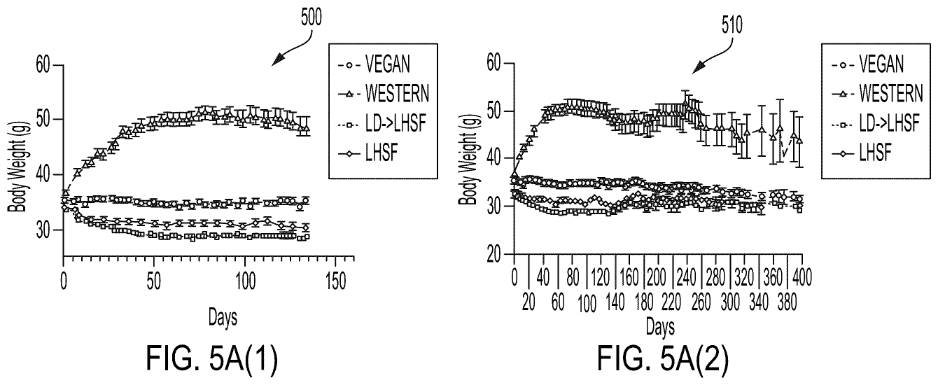

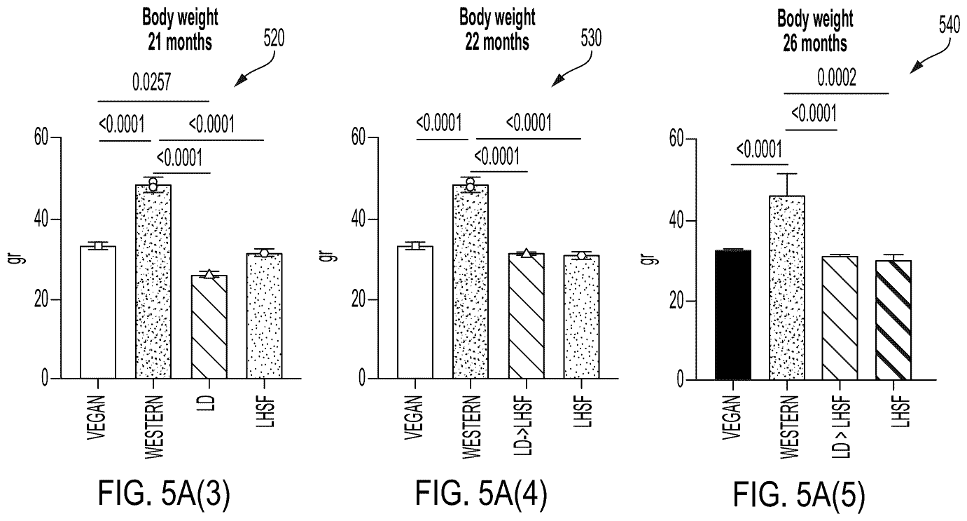

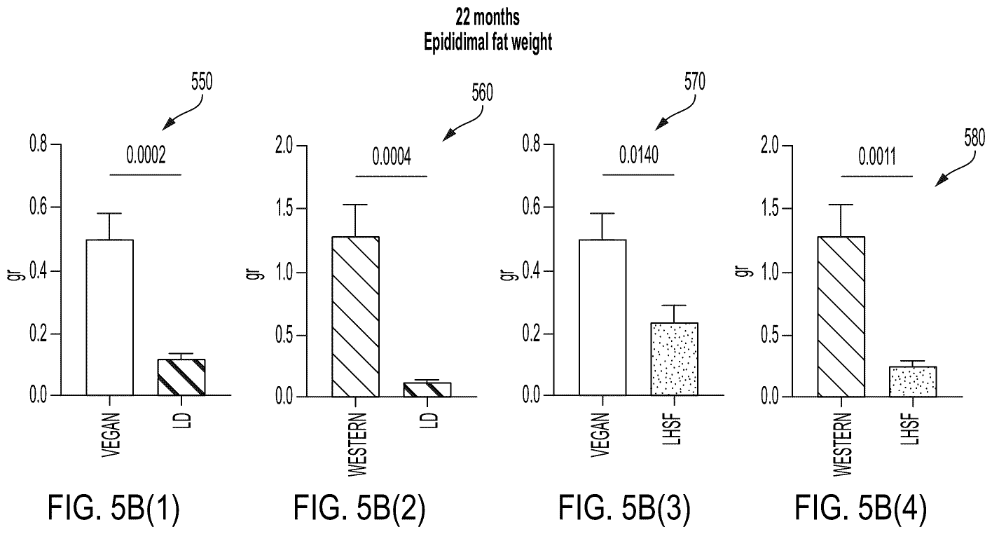

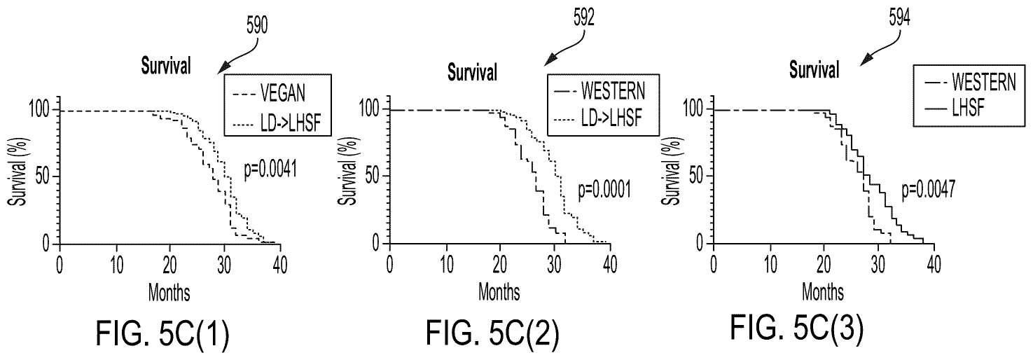

FIG. 5 are graphs 500, 510, 520, 530, 540, 550, 560, 570, 580, 590, 592, 564 showing the impact of switching mice from a standard chow to different diets. FIGS. 5A(1)-5(A)(5), FIGS. 5B(1)-5B(4) and FIGS. 5C(1)-5C(3). C57BL/6 male mice were switched from a standard chow to the different diets when they were 16 months old and the new diet continued until death. Longevity Diet (LD) and Longevity High Strength and Function (LHSF) decrease body weight (FIGS. 5A(1)-5(A)(5)) and epididymal fat weight (FIGS. 5B(1)-5B(4)). LD in particular causes sever weight loss (20% decrease compared to baseline level) (FIGS. 5A(1)-5(A)(5)). Therefore, at 21 months of age, mice fed with LD were switched to LHSF diet and the switch allowed mice to restore body weight at the same level of mice fed with LHSF from the beginning. Notably mice fed with LHSF after LD or fed with LHSF from the beginning, show an extended survival compared to mice fed with vegan diet and western diet (FIGS. 5C(1)-5C(3)).

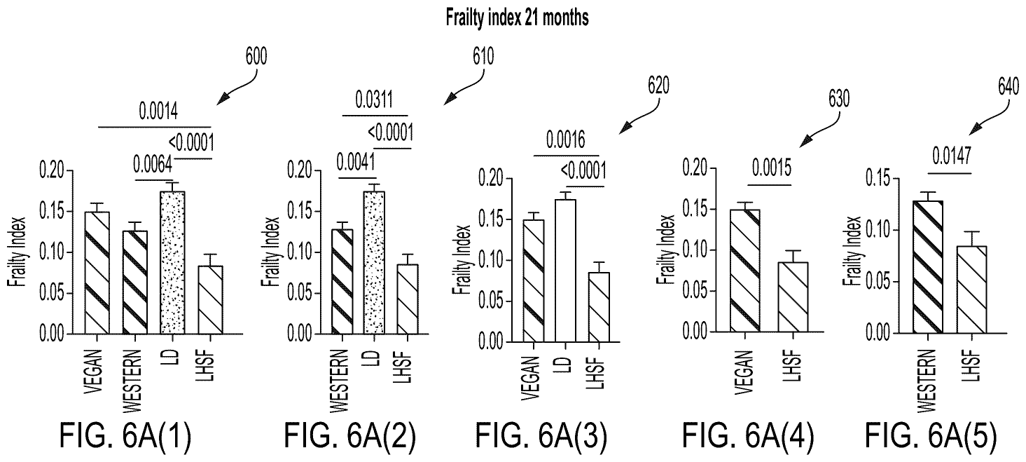

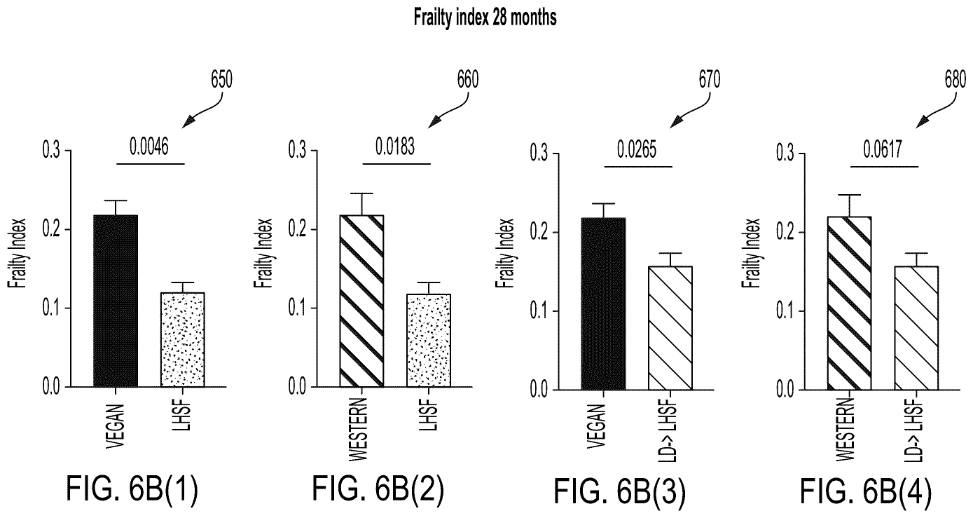

FIGS. 6A(1)-6A(5) and FIGS. 6B(1)-6B(4) are bar graphs 600, 610, 620, 630, 640, 650, 660, 670, 680 showing frailty over time. Mice fed with LHSF are less frail compared to mice fed with vegan and western diet. LD increases frailty at 21 months (FIGS. 6A(1)-6A(5)), however the effect is reversed upon switching to LHSF (FIGS. 6B(1)-6B(4)). At 28 months, in fact, mice fed with either LHSFT after LD (LD->LHSF) or fed with LHSF from the beginning show a lower frailty index compared with mice fed with western and vegan diet (FIGS. 6B(1)-6B(4)).

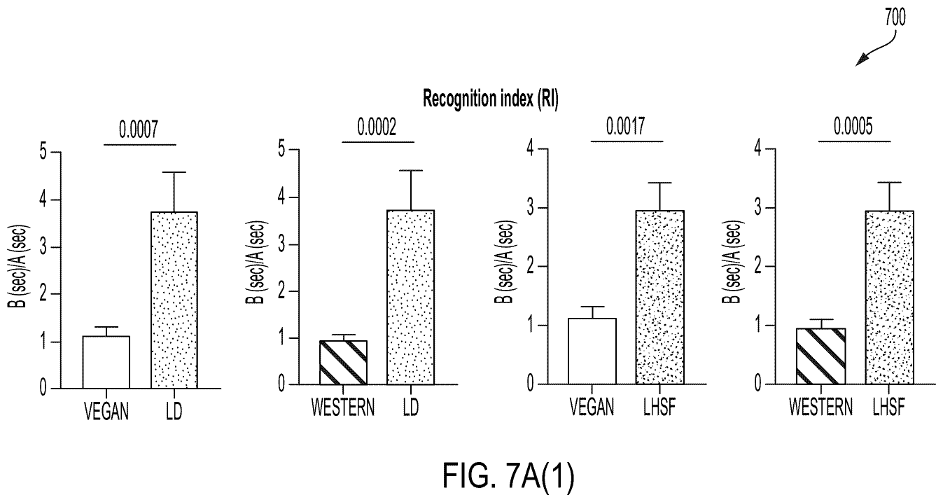

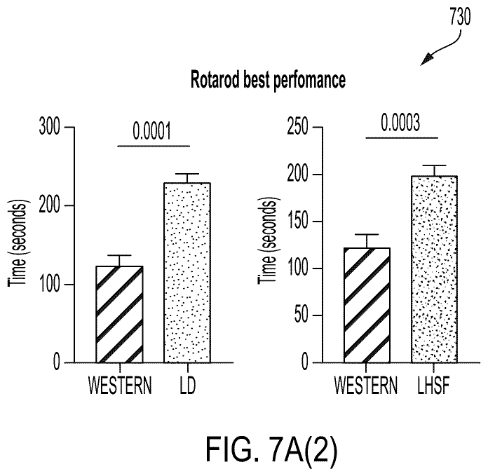

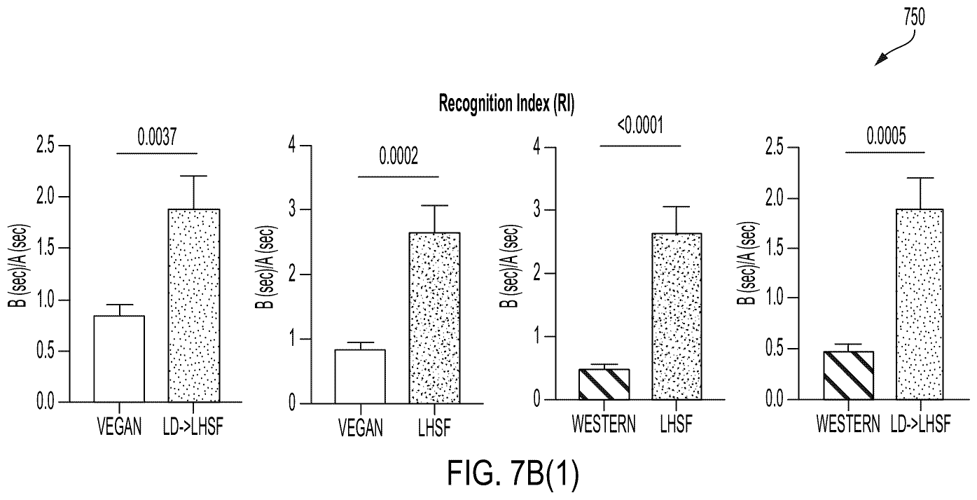

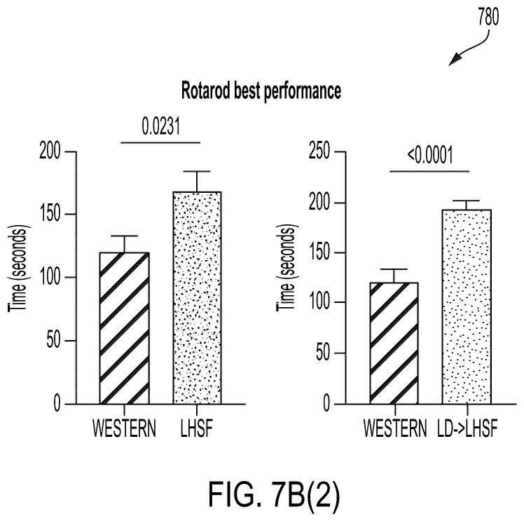

FIGS. 7A(1)-7A(2) and FIGS. 7B(1)-7B(2) are bar graphs 700, 730, 750, 780 showing cognition performance and motor coordination over time. LD and LHSF improve cognitive performance and motor coordination, measured by recognition index and rotarod test in 22 (FIGS. 7A(1)-7A(2)) and 28 (FIGS. 7B(1)-7B(2)) month old mice.

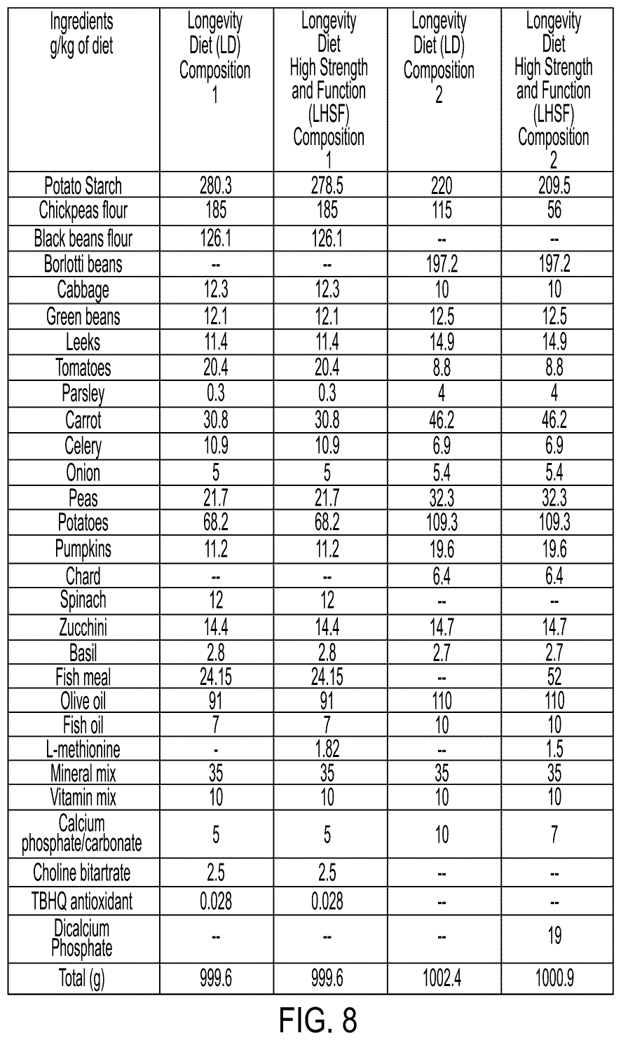

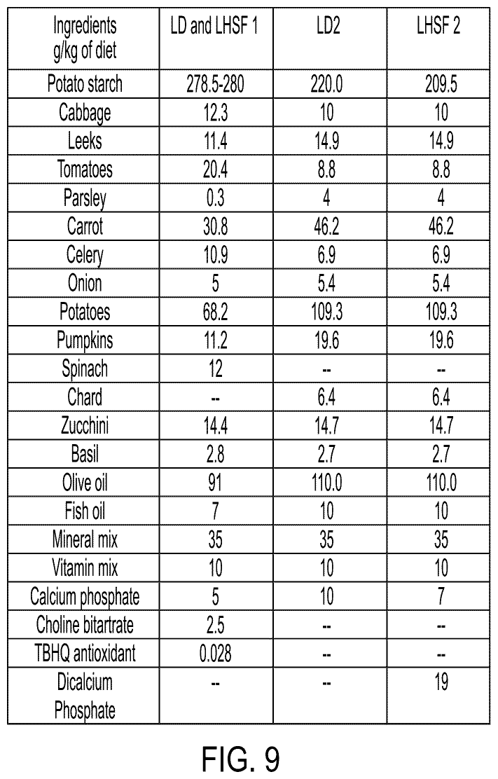

FIGS. 8 and 9 are tables providing suitable formulations for the LD composition and the LHSF compositions. It should be appreciated that practice within plus or minus 30 percent of the values indicated is also contemplated.

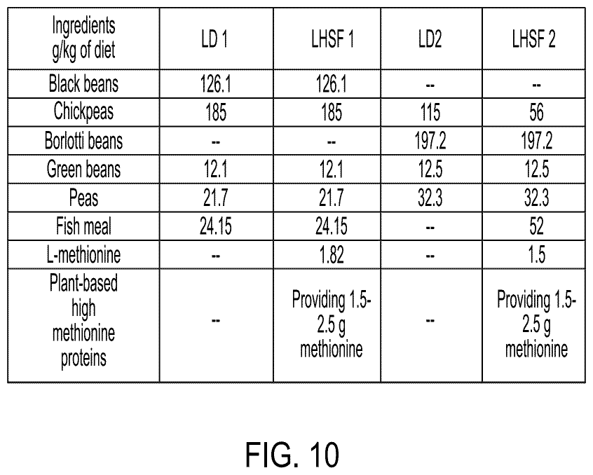

In still another aspect, a proteins/amino acid supplement composition shown in FIG. 10 can be used in combination with the compositions of FIG. 8 and FIG. 9. Advantageously, the formulation of the longevity diet can be used as a substitution meal in combination as needed with protein source supplementation to optimize frailty and longevity. The table in FIG. 10 provides an example of the protein/amino acid supplement composition. It should be appreciated that practice within plus or minus 30 percent of the values indicated is also contemplated.

The following examples illustrate the various embodiments of the present invention. Those skilled in the art will recognize many variations that are within the spirit of the present invention and the scope of the claims.

Studies conducted on old male C57BL6 mice and both female and male HET3 mice, considered the gold standard for aging study, have shown that continuous administration of the nutritional formulation for the LD leads to significant improvements in overall health and metabolic markers/risk factors. The LD, without any calorie or time restriction, has shown to be effective in controlling blood glucose, and remodeling body composition with effects on biomarkers for metabolic dysfunction and aging-related diseases. These effects are attributable to the specific composition of the diet which ranges from high fiber and nourishment to low content of proteins and specific amino acids.

The LD is a nutritional plan based on plant-based food and a small portion of fish derivates. The LD provides 58% of its calories from non-refined complex carbohydrates, 12% from proteins provided by legumes and/or fish meals, and 30% from healthy fats provided by fish meals, fish oil, and olive oil. These last have been optimized, in terms of intake, to provide a balanced ratio of omega-6 fatty acids to omega-3 fatty acids is from 1 to 4, more specifically an omega-6 fatty acids to omega-3 fatty acids of around 2.8:1. As will be appreciated by those skilled in the art, any numeric ranges disclosed include all intervening integers for that range.

Examples of consumable products that can be manufactured to optimize strength and function according to the disclosure include, but are not limited to: nutrition bar consumables; ready-to-drink meal replacement consumables (RTD) such as shakes or smoothies; spoonable consumable (e.g., custard or pudding consistency consumable); a squeezable consumable (e.g., creamy consumable); crisp consumable; chip consumable; cracker consumable; and frozen consumables (such as ice-cream, sorbet or frozen-yogurt type options). The consumables are formulated from a plant-based protein that is optimized to nourish muscles, bones and other essential organs while maintaining aging factors such as IGF-1 and insulin in a range that is optimal for healthy aging and longevity lifestyle.

More specifically, the consumables are formulated to strike an in vivo balance for the person consuming the consumables of insulin, IGF-1 and other hormones. Balancing insulin and IGF-1 allows the body to thrive in a short term with premium nutrition while not exceeding its natural biological aging rate. The consumables are also formulated for safe daily consumption.

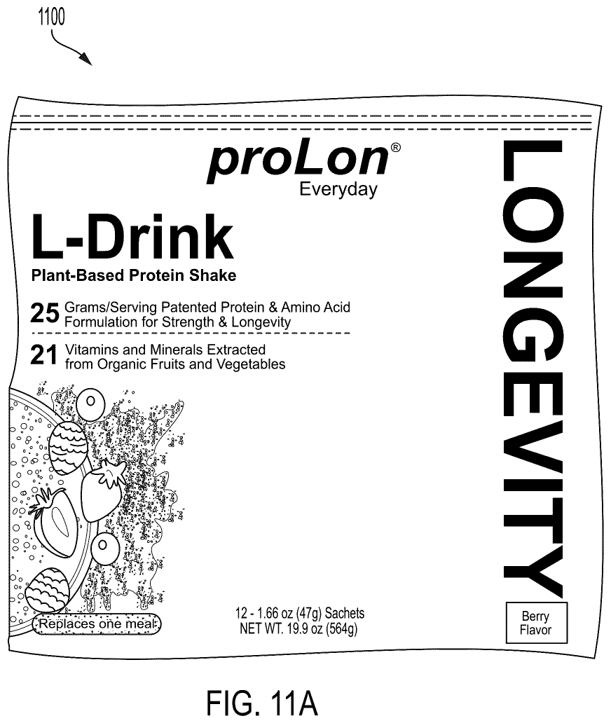

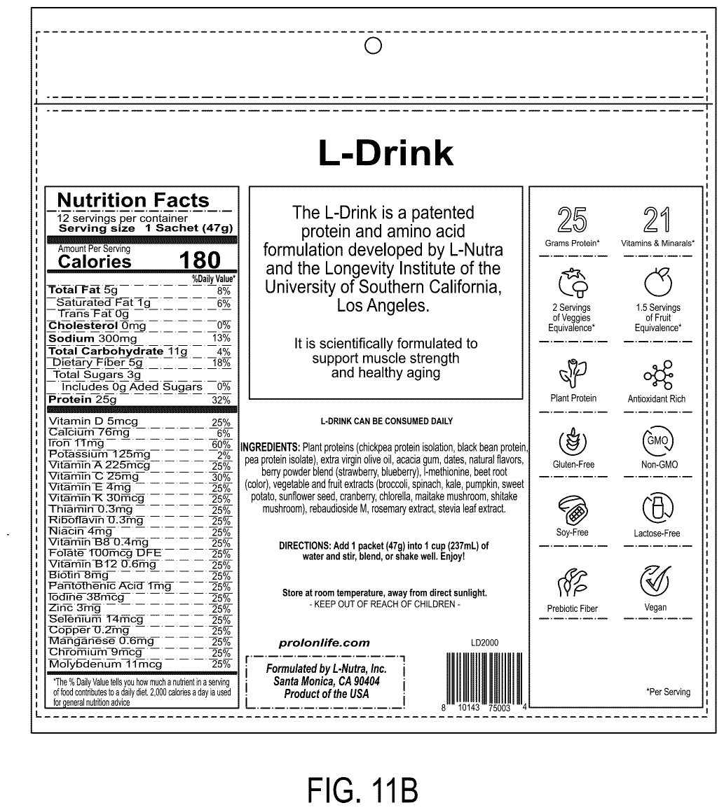

Turning now to specific examples of consumable products manufactured to optimize strength and function, FIGS. 11A-11B are nutritional information 1100, 1110 for a longevity extending consumable product in the form of a plant-based protein shake. The plant-based protein shake has, for example, 25 grams/serving of protein and amino acids formulated for strength and longevity. Additionally, 21 vitamins and minerals can be included in the formulation which is provided in a powder form and packaged with a weight of 1.66 oz (47 g). The formulation has 190 calories, 6 g of fat (1 g saturated fat and zero trans fat), 0 mg cholesterol, 250 mg of sodium, 11 g of total carbohydrate (4 g of dietary fiber and 3 g total sugar), and 25 g of protein. The ingredients include plant proteins (e.g., chickpea protein isolate, black bean protein, black bean flour, pea protein isolate), extra virgin olive oil, acacia gum, dates, natural flavors, berry powder blend (e.g., strawberry and blueberry), 1-methionine, konjac, beet root, vegetable and fruit extracts (e.g., broccoli spinach, kale, pumpkin, sweet potato, sunflower seed, cranberry, chlorella, maitake mushroom, shitake mushroom), rebaudioside M (a steviol glycoside from the Stevia plant), rosemary extract, stevia leaf extract. The formulation is antioxidant rich, gluten free, soy-free, lactose-free and vegan. Additionally, the formulation contains prebiotic fiber and has an equivalence of 2 servings of vegetables and 1.5 servings of fruit.

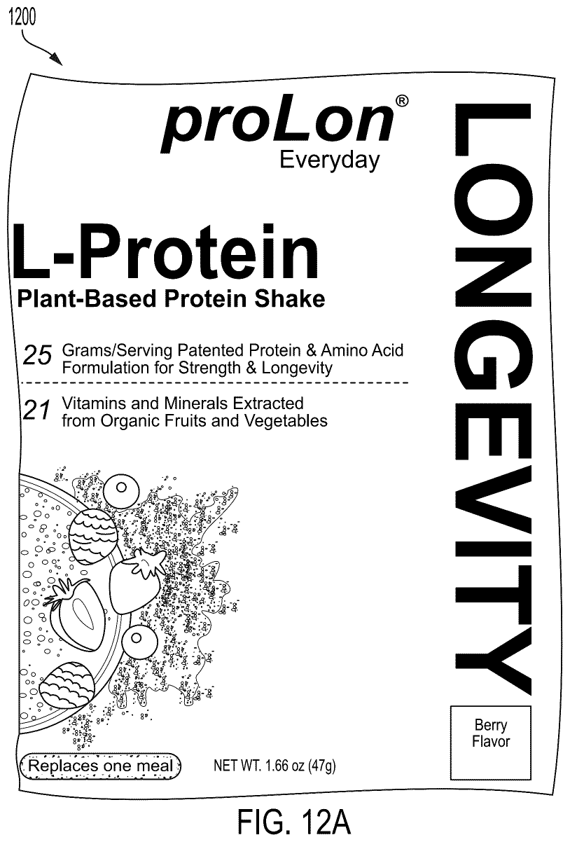

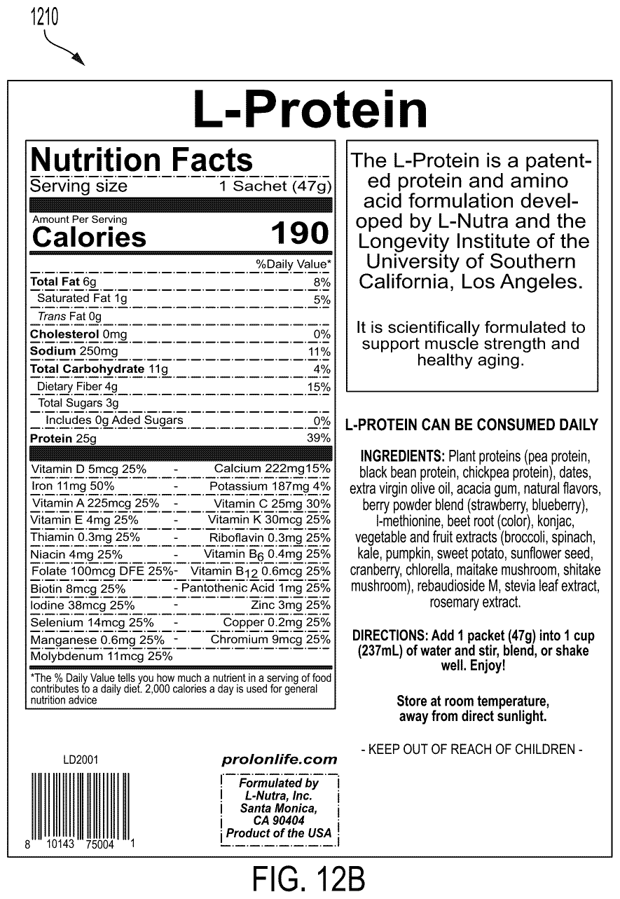

FIGS. 12A-12B are nutritional information 1200, 1210 for a longevity extending consumable product for maximizing strength and function also in the form of a plant-based protein shake. The plant-based protein shake has, for example, 25 grams/serving of protein and amino acids formulated for strength and longevity. Additionally, 21 vitamins and minerals can be included in the formulation which is provided in a powder form and packaged with a weight of 1.66 oz (47 g). The formulation has 190 calories, 6 g of fat (1 g saturated fat and zero trans fat), 0 mg cholesterol, 250 mg of sodium, 11 g of total carbohydrate (4 g of dietary fiber and 3 g total sugar), and 25 g of protein. The ingredients include plant proteins (e.g., pea protein, black bean protein, black bean flour, chickpea protein), dates, extra virgin olive oil, acacia gum, natural flavors, berry powder blend (e.g., strawberry and blueberry), 1-methionine, beet root, konjac, vegetable and fruit extracts (e.g., broccoli spinach, kale, pumpkin, sweet potato, sunflower seed, cranberry, chlorella, maitake mushroom, shitake mushroom), rebaudioside M, stevia leaf extract, and rosemary extract.

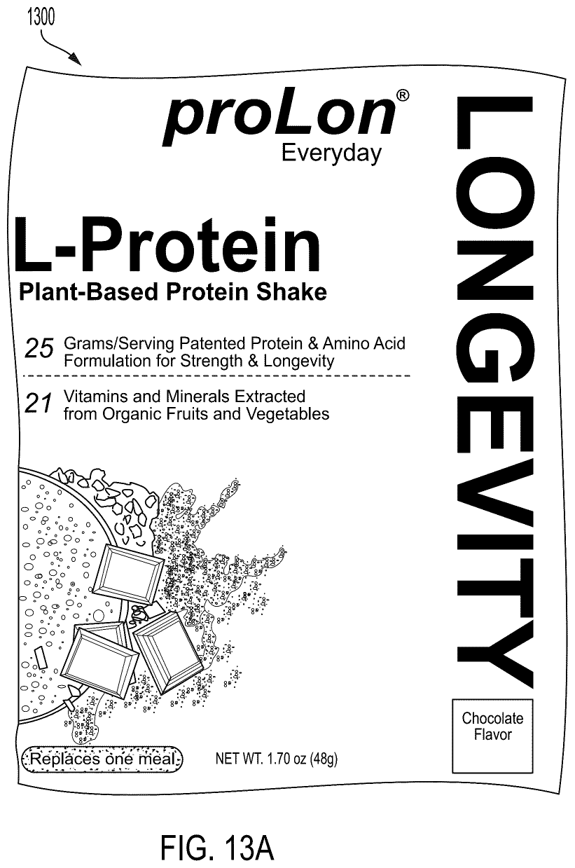

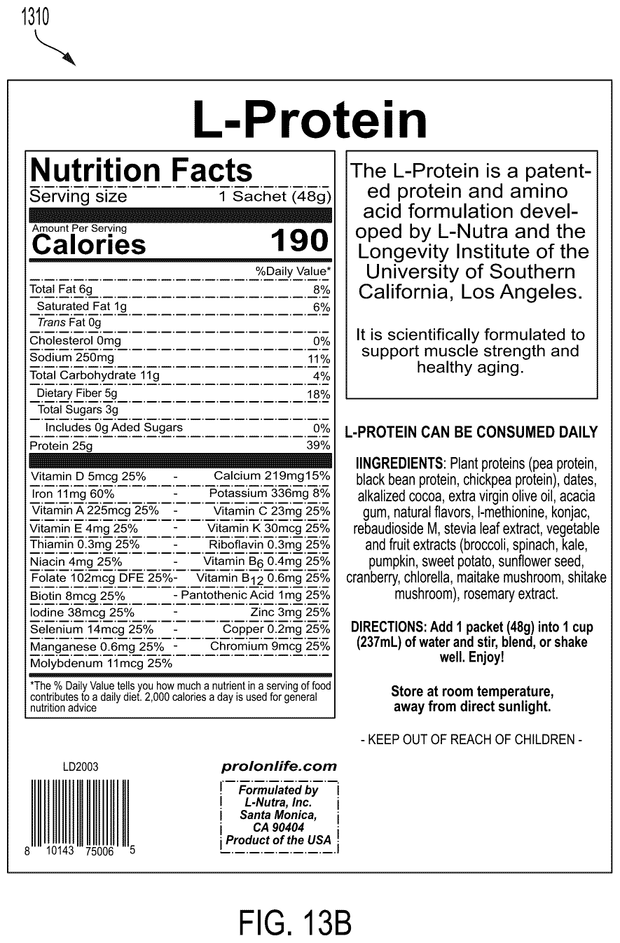

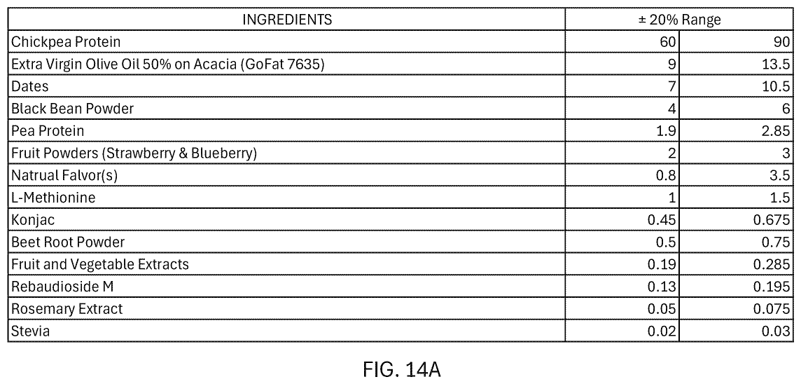

FIGS. 13A-13B are nutritional information 1300, 1310 for a longevity extending consumable product for maximizing strength and function also in the form of a plant-based protein shake. The plant-based protein shake has, for example, 25 grams/serving of protein and amino acids formulated for strength and longevity. Additionally, 21 vitamins and minerals can be included in the formulation which is provided in a powder form and packaged with a weight of 1.69 oz (48 g) (as shown) to a weight of 1.76 oz (50 g) (not shown). The formulation has 190 calories, 6 g of fat (1 g saturated fat and zero trans fat), 0 mg cholesterol, 250 mg of sodium, 11 g of total carbohydrate (5 g of dietary fiber and 3 g total sugar), and 25 g of protein. The ingredients include plant proteins (e.g., pea protein, black bean protein, chickpea protein), dates, alkalized cocoa, extra virgin olive oil, acacia gum, natural flavors, 1-methionine, konjac, rebaudioside M, stevia leaf extract, vegetable and fruit extracts (e.g., broccoli spinach, kale, pumpkin, sweet potato, sunflower seed, cranberry, chlorella, maitake mushroom, shitake mushroom), and rosemary extract.

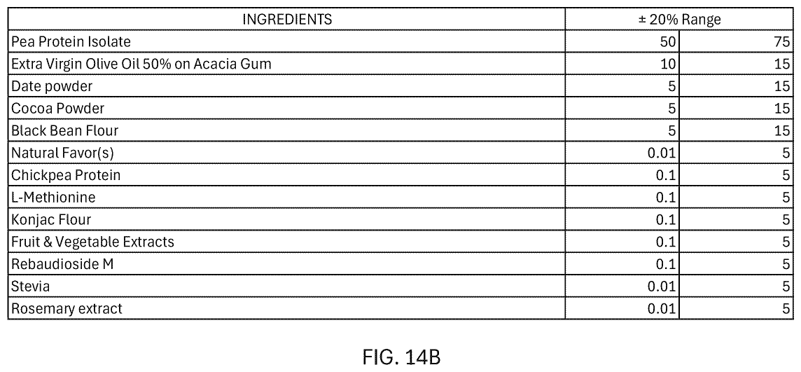

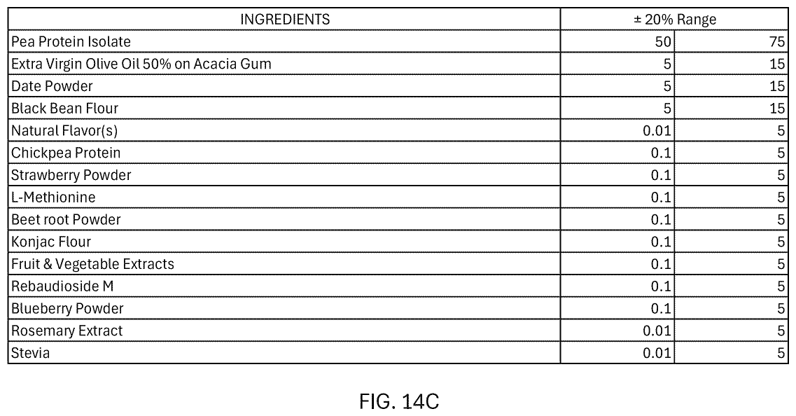

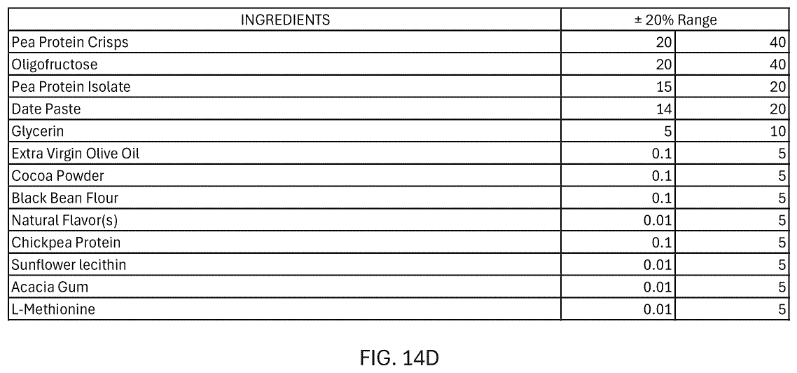

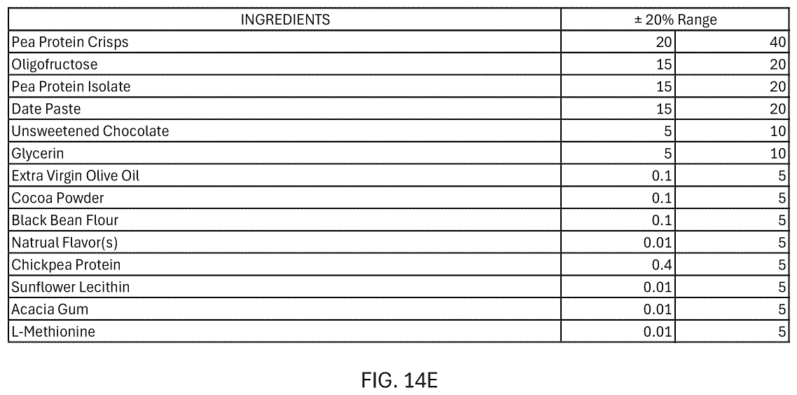

FIGS. 14A-14E are ingredients for exemplar longevity extending consumable products for maximizing strength and function. The formulations are expressed in weight percentage ranges. As will be appreciated by those skilled in the art, each range can have an interval. For example, an interval variance can be +/−20%, inclusive. Moreover, the actual percentage of each ingredient can be any amount within the variance (+/−20%), provided that the resulting composition is theoretically possible. For example, as would be understood by one skilled in the art, it is not possible to rely on the variance such that a composition has components totaling greater than 100% of the weight of the composition or less than 100% of the weight of the composition. Additionally, the actual percentage can be selected so that the percentage does not include the median value. As will be appreciated by those skilled in the art, the ingredients can be referred to by either a technical name or a common nomenclature name. Moreover, additional ingredients can be provided. Pea protein crisps, as used herein, are pea proteins stabilized on a stabilizing agent, such as rice starch.

FIGS. 14A-14C notes that extra virgin olive oil is on acacia (GoFat 7635). This is because extra virgin olive oil is a liquid and must be dispersed or otherwise stabilized in a powder form. Here, it may be sprayed or otherwise combined with an acacia gum or fat, such as GoGat 7635. This combination allows the olive oil to be dispersed as a powder. While acacia gums are exemplified here, any stabilizer known in the art can be used. Without wishing to be bound by theory, to stabilize olive oil as a powder, emulsifiers and encapsulating agents like acacia gum are commonly used due to their ability to form protective films around oil droplets, preventing oxidation and improving shelf life. Acacia gum may be combined with maltodextrin as a carrier or modified starch for enhanced encapsulation efficiency, while other options like whey protein isolate, cyclodextrins, or soy lecithin provide additional stabilization and functionality. These stabilizers, depending on the application, ensure the resulting powder is shelf-stable, free-flowing, and retains the oil's quality over time.

Preliminarily, the manufacturing process begins with obtaining ingredients, e.g., from a central location according to a formula blending sheet. Each ingredient is weighed individually. A second weight may be secured to ensure accuracy and quality. Additional information can be recorded during this process including, but not limited to recording supplier and/or lot information. Once pulled, all or a subset of ingredients are passed through a sifter into a mixer and allowed to blend for a period of time. Additional or partial ingredients can be passed through the sifter and into the mixer as desired for an additional mixing time. If a subset of ingredients has been added in the first step, then the remaining ingredients can be passed through the sifter into the mixing for mixing. Following the mixing step the mixed ingredients can be tested for quality. Once the quality of the batch is ensured, the mixed batch can be passed through the sifter and magnet into drums or totes before proceeding to packaging.

As would be appreciated by those of skill in the art, some formulations may be specifically designed for shakes in a powder form. While described in powder form, any mixture of this shake powder, in the disclosed proportions, mixed with a suitable carrier, such as water, is within contemplated in this disclosure. For example, a protein shake can be mixed with water such that the protein shake's final weight is 5%, 10%, 15%, 20%, 25%, 30%, 35%, 36.67%, 40%, 45%, 50%, 55%, 60%, 65%, 66.67%, 70%, 75%, 80%, 85%, and 90% powder and the balance water. All ranges possible between these numbers are contemplated as well, such as any mixture of the disclosed powder and water in the ratio of 5% powder to 80% through 60% powder and 40% water, or 10% powder to 90% water through 50% powder to 50% water. Shake formulations are identifiable by their powdery components, as would be appreciated by one of skill in the art. For example, the formulations of FIGS. 14A-14C can be powders for shakes.

More broadly, the consumable products manufactured according to these formulations can be made by weighing or measuring each ingredient, mixing (and/or pre-mixing when required) the raw ingredients. The ingredients are then placed in a large container and blended to ensure consistent presence of individual ingredients throughout the consumable. For a consumable bar, for example, after a wet or binding ingredient is added, the blend is compressed into a flat sheet of a desired thickness (e.g., 0.5 inches). The sheet of the mixed ingredients is then cut into a desired shape (such as a rectangular shape having a length of 3.5 inches, a width of 1.5 inches and a thickness of 0.5 inches) and allowed to dry forming a final product. Once dried the final product is packaged into, for example, a foil sleeve which is sealed via cold of heat sealing. For a consumable drink, a measured amount of the dry powder is obtained and placed into a foil sleeve which is sealed. The user adds the fluid and mixes with the powder prior to consuming the shake. For a consumable chips or crisps, for example, after a wet or binding ingredient is added, the blend is compressed into a flat sheet having a desired thickness (e.g. 0.1 inch). The sheet of the mixed ingredients is then cut into a desired shape or shapes (e.g. square, round, rectangular, ovoid, etc.) and baked or air fried forming a final product. The desired shape can have a length and a width suitable for consuming in a single bite. Once dried the final product is packaged into, for example, a foil sleeve which is sealed via cold of heat sealing.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

Various examples and embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While preferred embodiments of the present invention have been shown and described herein, it will be obvious to those skilled in the art that such embodiments are provided by way of example only. Numerous variations, changes, and substitutions will now occur to those skilled in the art without departing from the invention. For example, the use of comprise, or variants such as comprises or comprising, includes a stated integer or group of integers but not the exclusion of any other integer or group of integers. It should be understood that various alternatives to the embodiments of the invention described herein may be employed in practicing the invention. It is intended that any claims presented define the scope of the invention and that methods and structures within the scope of these claims and their equivalents be covered thereby.

What is claimed:

1. A composition for a consumable product for improving overall health and lifespan having a total calories, comprising:
non-refined complex carbohydrates in an amount ranging from about 10 to 50 percent of the total calories of the composition; and
healthy fats in an amount ranging from about 20 to 40 percent of the total calories of the composition,
wherein the consumable product is selected from a nutrition bar, a ready-to-drink meal replacement consumable, a spoonable consumable, a squeezable consumable, a crisp consumable, a chip consumable, a cracker consumable, a powder consumable, a shake consumable, and frozen consumables.

2. The composition for the consumable product of claim 1, wherein the healthy fats are at least partially provided by olive oil, avocado oil, nut oil, fatty fish oil, flaxseed oil, walnut oil, sunflower oil, sesame oil, safflower oil, soybean oil, grapeseed oil, pumpkin seed oil, pistachio oil, canola oil, peanut oil, hazelnut oil, macadamia nut oil, almond oil, algal oil, chia seed oil, hemp seed oil, fish oil, fish meal, omega-3 fatty acids, omega-6 fatty acids, or combinations thereof.

3. The composition for the consumable product of claim 1, further comprising proteins in an amount ranging from about 20 to 60 percent of the total calories of the composition.

4. The composition for the consumable product of claim 3, wherein the proteins are at least partially provided by a legume or fish meal.

5. The composition for the consumable product of claim 1, further comprising a carbohydrate component selected from potato starch, chickpea flour, black bean flour, borlotti beans, cabbage, green beans, leeks, tomatoes, parsley, carrot, celery, onion, peas, potatoes, pumpkins, chard, spinach, zucchini, basil, and combinations thereof, the carbohydrate component formulated to provide the non-refined complex carbohydrates in an amount ranging from about 10 to 40 percent of the total calories of the composition.

6. The composition for the consumable product of claim 1, further comprising a liquid carrier.

7. The composition for the consumable product of claim 6, wherein the liquid carrier includes water.

8. The composition for the consumable product of claim 1, further comprising a supplement component selected from a mineral mix, a vitamin mix, calcium phosphate, calcium carbonate, choline bitartrate, TBHQ antioxidant, dicalcium phosphate, and combinations thereof.

9. A method of manufacturing a consumable product from a composition for improving overall health and lifespan, comprising:
providing the following components:
non-refined complex carbohydrates in an amount ranging from about 10 to 50 percent of a total calories of the composition, and
one or more healthy fats in an amount ranging from about 20 to 40 percent of the total calories of the composition; and
combining the components into the consumable product,
wherein the consumable product is selected from a group comprising a nutrition bar, a ready-to-drink meal replacement consumable, a spoonable consumable, a squeezable consumable, a crisp consumable, a chip consumable, a cracker consumable, a powder consumable, a shake consumable, and a frozen consumable.

10. The method of manufacturing the consumable product from the composition of claim 9, wherein the healthy fats are at least partially provided by olive oil, avocado oil, nut oil, fatty fish oil, flaxseed oil, walnut oil, sunflower oil, sesame oil, safflower oil, soybean oil, grapeseed oil, pumpkin seed oil, pistachio oil, canola oil, peanut oil, hazelnut oil, macadamia nut oil, almond oil, algal oil, chia seed oil, hemp seed oil, fish oil, fish meal, omega-3 fatty acids, omega-6 fatty acids, or combinations thereof.

11. The method of manufacturing the consumable product from the composition of claim 9, further comprising proteins in an amount ranging from about 20 to 60 percent of the total calories of the composition.

12. The method of manufacturing the consumable product from the composition of claim 11, wherein the proteins are at least partially provided by a legume or fish meal.

13. The method of manufacturing the consumable product from the composition of claim 9, further comprising:
providing a carbohydrate component selected from potato starch, chickpea flour, black bean flour, borlotti beans, cabbage, green beans, leeks, tomatoes, parsley, carrot, celery, onion, peas, potatoes, pumpkins, chard, spinach, zucchini, basil, and combinations thereof, the carbohydrate component formulated to provide the non-refined complex carbohydrates in an amount ranging from about 15 to 50 percent of the total calories of the composition, wherein the carbohydrate component is additionally combined with the non-refined complex carbohydrates, proteins and healthy fats to create the consumable product.

14. The method of manufacturing the consumable product from the composition of claim 9, further comprising
providing a liquid carrier, wherein the liquid carrier is additionally combined with the non-refined complex carbohydrates, proteins and healthy fats to create the consumable product.

15. The method of manufacturing the consumable product from the composition of claim 14, wherein the liquid carrier includes water.

16. The method of manufacturing the consumable product from the composition of claim 9, further comprising
providing a supplement component selected from a group comprising a mineral mix, a vitamin mix, calcium phosphate, calcium carbonate, choline bitartrate, TBHQ antioxidant, dicalcium phosphate, and combinations thereof.

17. A method for improving overall health and lifespan, comprising:
substituting a meal for a subject with a consumable product made by the method of claim 9.

18. The method for improving overall health and lifespan of claim 17, wherein the one or more healthy fats are at least partially provided by olive oil, avocado oil, nut oil, fatty fish oil, flaxseed oil, walnut oil, sunflower oil, sesame oil, safflower oil, soybean oil, grapeseed oil, pumpkin seed oil, pistachio oil, canola oil, peanut oil, hazelnut oil, macadamia nut oil, almond oil, algal oil, chia seed oil, hemp seed oil, fish oil, fish meal, omega-3 fatty acids, omega-6 fatty acids, or combinations thereof.

19. The method for improving overall health and lifespan of claim 17, wherein the proteins are at least partially provided by a legume or fish meal.

20. The method for improving overall health and lifespan of claim 17, wherein the consumable product further comprises a carbohydrate component selected from a group comprising potato starch, chickpea flour, black bean flour, borlotti beans, cabbage, green beans, leeks, tomatoes, parsley, carrot, celery, onion, peas, potatoes, pumpkins, chard, spinach, zucchini, basil, and combinations thereof, the carbohydrate component formulated to provide the non-refined complex carbohydrates in an amount ranging from about 15 to 40 percent of the total calories of the composition.

21. The method for improving overall health and lifespan of claim 17, wherein the consumable product further comprises a liquid carrier.

22. The method for improving overall health and lifespan of claim 21, wherein the consumable product further comprises a supplement component selected from a group comprising a mineral mix, a vitamin mix, calcium phosphate, calcium carbonate, choline bitartrate, TBHQ antioxidant, dicalcium phosphate, and combinations thereof.
